(19) United States
(12) Patent Application Publication
(10) Pub. No.: US 2010/0043695 A1
(43) Pub. Date: Feb. 25, 2010

(54) COLOR CHANGING INDICATOR

(75) Inventors: Hans Reichert, Rheinfelden (DE); Tracey Nisbet, Scotland (GB)

Correspondence Address: Ciba Corporation;Patent Department, 540 White Plains Road, P.O. Box 2005, Tarrytown, NY, 10591, US

(73) Assignee: CIBA CORPORATION, Tarrytown, NY (US)

(21) Appl. No.: 12/527,439

(22) PCT Filed: Feb. 18, 2008
(86) PCT No.: PCT/EP2008/051911

§ 371 Date: Oct. 8, 2009

(30) Foreign Application Priority Data
Feb. 27, 2007 (EP) 07103103.3

(51) Int. Cl. G01K 1/02; B05D 1/36; C09K 11/02

(52) U.S. Cl. 116/207; 427/402; 106/31.49; 116/216

(57) ABSTRACT

The present invention relates to an indicator system comprising (a) an indicator system comprising a) a photo- or thermochromic indicator compound and b) a luminescent colorant which increases the color difference of the color change of the reagent by at least 0.5 units.

The present invention relates to an indicator system comprising (a) an indicator reagent which enables to follow the course of a chemical and/or physical process or characterize the state of a chemical and/or physical system by generating a visually distinct color signal due to a color change of the indicator reagent, and (b) a colorant which increases or decreases, preferably increases the color difference of the color change of the reagent by at least 0.5 color units.

Color-forming or color-changing temperature-sensitive indicators are capable of monitoring the handling (in terms of time and/or temperature) of perishable goods and their use for this purpose is increasing. The utility of such indicators is to signal when a perishable article to which the indicator is attached has reached the point of quality loss, or unsafe condition, due to periods of excessive temperature exposures after which the product should no longer be used, or the product should be closely scrutinized to ensure suitable quality prior to being used. Indicator systems of this nature are important to ensure the quality and safety of perishable foods, pharmaceuticals, chemicals, and other such sensitive items.

U.S. Pat. No. 5,057,434 discloses a time temperature indicator device which can be used to monitor full shelf life of the product at proper storage temperature and to monitor a temperature abuse at elevated temperatures. The indicator device comprises three layers. The first layer contains a color developer (e.g. a spiropyrane). The second layer is a meltable layer such as a polyethylene glycol layer. The third layer contains a second color developer which can diffuse to the first color developer as soon as the polyethylene glycol has melted. The polyethylene glycol melts at improper storage temperature.

The European Publication EP309173 teaches a time temperature indicator comprising a polar indicator dye (e.g. a spiropyrane) in the presence of a room temperature volatile solvent which is initially present in excess and a small amount of a proton donating compound. The indicator operates by balancing the ratio of the amount of solvent present versus the amount of proton donating compound. The indicator dye has a first color or is colorless when the solvent is in excess and a second color when the solvent is depleted and the proton donating compound is present in a relatively high concentration. The indicator is restricted to use in a non aqueous solvent.

There remains a need for an indicator system wherein the observed color change better reflects the kinetic course of an indicator reaction or better indicates the current status of a system to be analyzed. In essence, what is desirable are greater color switches along a given indicator kinetic, meaning a more distinct color change to clearly show that a pre-arranged sub-interval of time has ended in case of time temperature indicators. The time indicator would particularly solve the problems with longer term indicators that suffer from an extended “gray time” where there is a slow change in the indication color. The time indicator would provide for a more precise method of determination of how much time has actually been elapsed since the activation of the indicator during the “gray time” of such an indicator.

It was found that when using a luminescent colorant, preferably a bright luminescent yellow, it is possible to dramatically increase the ΔE color value and achieve two advantages, one is the strong color, the second is shorter lifetime due to the strong background that pops into one's eye faster than normally achieved using white background.

Hence, a first aspect of the present invention relates to a time temperature indicator system comprising

(a) a photo- or thermo chromic indicator compound and
b) a luminescent colorant.

For example, by virtue of its photochromic properties, a photochromic indicator compound can undergo photo-induced coloration by irradiation with photons of a specific energy range (conversion of the second isomeric form into the first isomeric form), the coloration being followed by a time- and temperature-dependent decoloration (conversion of the first isomeric form into the second isomeric form). The coloration of the indicator compound can take place at a defined timepoint, preferably, for example, immediately after printing onto a substrate, which is especially the packaging of a perishable material. It is preferred when the photochromic indicator compound being the active material of the time temperature integrator arrangement is re-chargeable and embedded in a matrix in form of a plurality of small crystals.

The time-temperature clock can be started at a defined desired timepoint and does not begin to run irreversibly at the time of the indicator synthesis. Decoloration is preferred for consideration according to the invention, but the use of an indicator in which the coloration process forms the basis of the time-temperature clock is also conceivable.

After printing and activation, the time-temperature integrator is, if necessary, provided with a protector, which prevents the renewed photo-induced coloration of the reversible indicator. Such a protector may be a protective coating (overprint varnish) or a laminate that comprises a filter, which, by filtering out certain wavelength ranges, is intended to prevent undesirable renewed coloration of the indicator after the time-temperature clock has started.

In addition, for the purpose of tamper-proofing, it is possible for a further, irreversible indicator to be arranged e.g. alongside or over the reversible indicator. The further indicator indicates by means of an irreversible color change that the reversible indicator has undergone renewed coloration after production or packaging of the perishable goods.

It is also possible to use indicators having more than one characteristic time domain. Such indicators can have, for example, a phase transition, with the different phases exhibiting different decoloration behaviours. The simultaneous use of two or more indicators having different time domains is likewise possible. Also, it is possible to include other indicators, for example those indicating storage of the perishable product at a temperature exceeding a predetermined limit.

Suitable time temperature indicator materials include but are not limited to diarylethene and spiroaromatic compounds which are reversible and bi-stable photochromic materials that exhibit a change in color in response to time and/or temperature changes, as well as light changes. (Claim 2)

Of all diarylethene and spiroaromatic derivatives, materials that exhibit the following characteristics are especially suitable for time temperature indicator applications:
(1) the system has at least one thermal process leading from at least one metastable state to at least one stable state, where the two states are characterized by distinctly different colours;
(2) the stable state may be converted to the at least one metastable state using one or any combination of stimuli, among others the following processes: a) photonic induction, b) thermal induction, c) pressure induction, d) electrical induction, or e) chemical induction; and
(3) other than temperature, the metastable state is substantially not affected or can be made is substantially not affected by any combination of device and or other effects, such as optical filter for reducing the effect of light, by anyone or any combination of stimuli such as a) photo induction, b) piezo induction, c) electro induction, d) chemo induction.

The spiroaromatic compound is expressed of the general formula (I) as the active time temperature indicator material

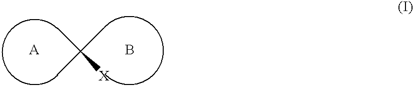

wherein
ring A represents a C5-C8 carbocycle, C4-C7 heterocycle containing at least one heteroatom selected from N, O, or S; said N heteroatom may be further substituted by one or two groups selected from C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl, or —CH═CH—CN; when said N heteroatom is tetrasubstituted it is positively charged and is associated with an anion selected from the group consisting of organic or inorganic anions; said C5-C8 carbocycle or C4-C7 heterocycle may be substituted by one or more of the groups selected from halogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, cyano, nitro, sulfo, hydroxyl, thiol, —CH═CH—CN, azido, amido or amino;
ring B represents a substituted or unsubstituted heterocycle containing at least one heteroatom X, said X being selected from N, O, and S; wherein said N atom may be further substituted by one or two groups selected from C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl, or —CH═CH—CN; when said N heteroatom is tetrasubstituted it is positively charged and is associated with an anion selected from the group consisting of organic or inorganic anions;
and wherein said ring B may contain one or more endocyclic double bonds and is optionally substituted by one or more halogen, preferably by one or more fluoro atoms; said rings A and B may be fused to one or more substituted or unsubstituted carbocycle, C4-C14 heterocycle, C6-C14 aryl or C4-C14 heteroaryl ring system;
and wherein the compounds of general formula I may be neutral, charged, multiply charged, positively charged having an external anion, negatively charged having an external cation or zwitterionic.

In one embodiment the spiroaromatic compounds of general formula (I) are spiropyran derivatives of 1′,3′,3′-trimethyl-6-nitro-spiro(2H-1-benzopyran-2,2′-2H-indole) of general formula (II)

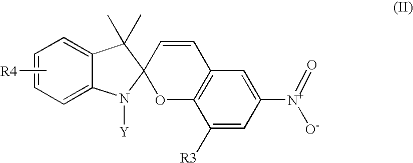

wherein
R3 is selected from the group consisting of H, halogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, or azido; wherein said alkyl, alkenyl, alkynyl, aryl, heteroaryl, and non-aromatic carbocycle may be substituted by one or more group selected from halogen, hydroxyl, thiol, amino, alkoxy, nitro, azido, or sulfo;
R4 is selected from the group consisting of hydrogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl or —CH═CH—CN; and
Y is selected from the group consisting of C1-C25 alkyl, preferably methyl, n-propyl and n-octadecyl, and C7-C15 aralkyl, wherein said alkyl and aralkyl may be substituted by one or more group selected from halogen, preferably fluorine.

Specific examples of preferred spiroaromatic compounds for the use in the time temperature indicator application according to the present invention include:

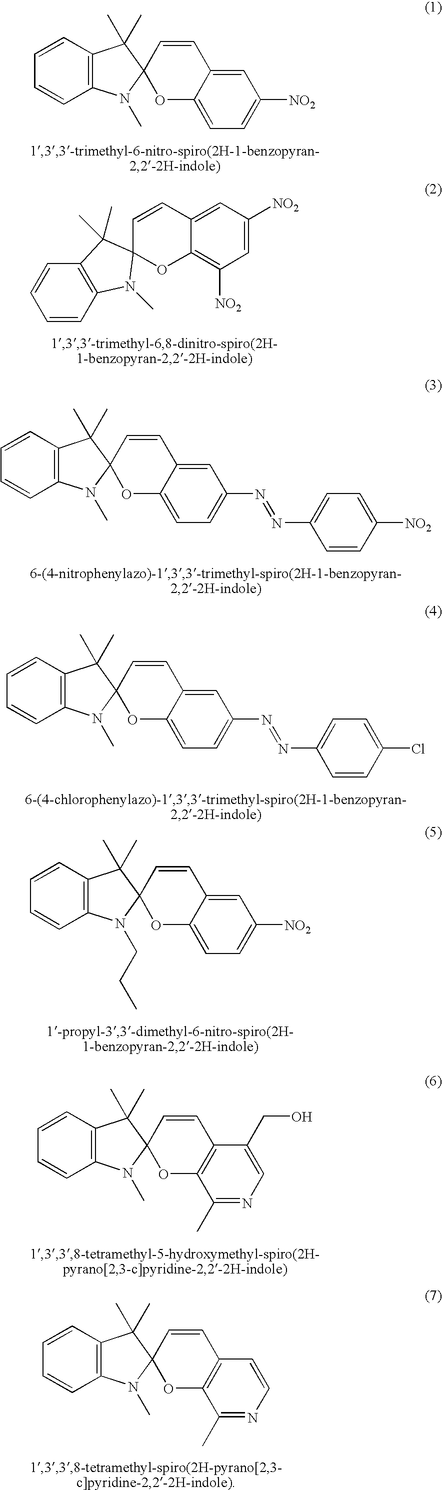

Further specific examples of preferred spiroaromatic compounds for the use in the time temperature indicator application according to the present invention also include compounds (8) to (25) in Table 1:

TABLE 1

| | |
|---|---|
| | (III) |
| 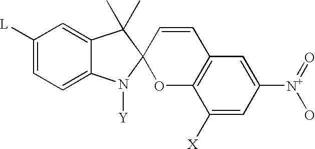 | |

| Compound | L | Y | X |
|---|---|---|---|
| 8 | H | methyl | H |
| 9 | H | n-propyl | H |
| 10 | H | n-octadecyl | H |
| 11 | H | 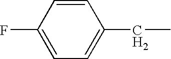 | H |
| 12 | Cl | methyl | H |
| 13 | Cl | n-propyl | H |
| 14 | Cl | n-octadecyl | H |
| 15 | Cl | 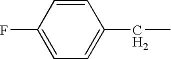 | H |
| 16 | Br | methyl | H |
| 17 | Br | n-propyl | H |
| 18 | Br | n-octadecyl | H |
| 19 | Br | 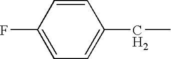 | H |
| 20 | I | methyl | H |
| 21 | I | n-propyl | H |
| 22 | I | n-octadecyl | H |
| 23 | I | 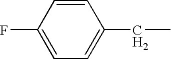 | H |
| 24 | H | 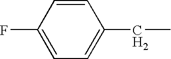 | methoxy |
| 25 | H | 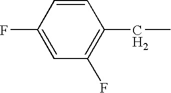 | methoxy |

As used therein, the term “substituted” refers to a radical in which, any one or more of the existing C—H bonds is replaced by a C—W bond wherein the W atom may be any one or more of the indicated substituent groups, or a combination thereof.

The term “derivative” as used herein, refers to a compound similar in structure to the another compound, and which may be produced from said another compound in one or more steps as in replacement of H by an alkyl, acyl, amino or any other group.

The term “endocyclic double bond” refers to cyclic radicals which contain one or more C═C, C═Y and/or Y═Y inner-cycle double bonds wherein C is a carbon atom and Y is a heteroatom such as, but not limiting to, N, O, or S. When Y is a divalent heteroatom such as O or S, the system may be charged. Examples for C═C and C═Y endocyclic double bonds are, without being limited to, cyclopentenyl, cyclohexenyl, benzopyrenyl, indolyl, 2H-benzo[e][1,3]oxazinyl, indazolyl and the like. The term “exocyclic double bond” refers to a cyclic radical which contains one or more C═C, C═Y and/or Y═Y out-of-ring double bond wherein Y is as defined above. Examples for cyclic radicals containing exocyclic double bond are, without limiting thereto, dihydrofuryldione, furyl-2,5-dione, cyclopent-1-yl-3-one, 3,3,4,4-tetrafluoro-5-methylenecyclopenten-1-yl and the like.

The term “alkyl” typically refers to a straight or branched alkyl radical and includes for example methyl, ethyl, n-propyl, isopropyl, n-butyl, isobutyl, tert-butyl, n-pentyl, 2,2-dimethylpropyl, n-hexyl and the like. Preferred alkyl groups are methyl, ethyl and propyl. The term “alkenyl” refers to a straight or branched hydrocarbon radicals typically having between 2 and 6 carbon atoms and one preferably a terminal double bond and includes for example vinyl, prop-2-en-1-yl, but-3-en-1-yl, pent-4-en-1-yl and the like. The terms “alkoxy”, “alkylthio” and “alkanoyl” refer to the groups alkyl-O—, alkyl-S—, and alkyl-CO— respectively, wherein “alkyl” is as defined above. Examples of alkoxy are methoxy, ethoxy, hexoxy and the like. Examples of alkylthio are methylthio, propylthio, pentylthio and the like, and examples of alkanoyl are acetyl, propanoyl, butanoyl and the like.

The term “aryl” as used herein refers to aromatic carbocyclic group having 6 to 14 carbon atoms consisting of a single ring or multiple rings such as phenyl, naphthyl, phenanthryl and the like. The term “heteroaryl” refers to monocyclic, bicyclic or tricyclic heteroaromatic group containing one to three heteroatoms selected from N, S and/or O such as, but not limited to, pyridyl, pyrrolyl, furyl, thienyl, imidazolyl, oxazolyl, quinolinyl, thiazolyl, pyrazolyl, quinazolinyl, 1,3,4-triazinyl, 1,2,3-triazinyl, benzofuryl, isobenzofuryl, indolyl, imidazo[1,2-a]pyridyl, benzimidazolyl, benzthiazolyl and benzoxazolyl.

The term “halogen” refers to fluoro, chloro, bromo or iodo. The term “perfluoro” or “perfluorated” refers to a radical in which all hydrogen atoms were replaced by F atoms. For Example, a perfluorated methyl group refers to —CF₃.

The term “charged group” refers to any one or more groups capable of taking on negative or positive charge or charges. Examples of such groups are ammonium, phosphonium, phenolate, carboxylate, sulphonate, thiolate, selenate and those mentioned herein before. The charge may be localized or delocalized and may be positive or negative. The term “group substituted by another group having a charge” refers to neutral radicals being substituted by charged groups as defined hereinbefore. The terms charged heteroatoms, charged heteroaryl, or charged group encompass zwitterionic systems as well.

The synthesis of the spiroaromatic compounds used with the indicators of the present invention, may be prepared according to synthetic routes known in the literature (see for example FIGS. 2, 6 and 7 in WO 2005/075978 A1).

The spiropyrane compound may also be a dimeric spiropyrane of the formula IV

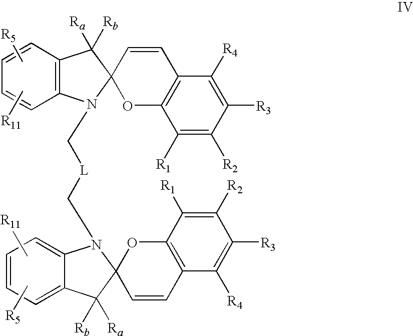

wherein
R₁ is hydrogen, —C₁-C₆ alkoxy, halogen, —C₁-C₆ alkyl or —NO₂;
R₂ is hydrogen or —C₁-C₆ alkoxy;
R₃ is NO₂ or halogen;
R₄ is hydrogen, —C₁-C₆ alkoxy or halogen;
R₅ is hydrogen, halogen, methoxy or —COOH
R₁₁ is hydrogen,
Rₐ is methyl or ethyl,
R_{b} is methyl or ethyl,
L is a divalent linker.

The term “divalent linker” as used herein refers to any divalent group capable of linking two or three spiropyran moieties together.

Examples of divalent linker groups are selected from C₁-C₁₂ alkylene, C₁-C₁₂ alkenylene, C₁-C₁₂ alkynylene,

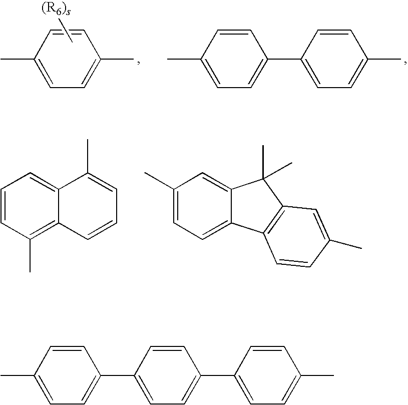

wherein R₆ is hydrogen, halogen, —C₁-C₆ alkoxy, CF₃, NO₂, preferably methoxy or hydrogen.
s. is 1-4, preferably 1 or 2.

Examples are:

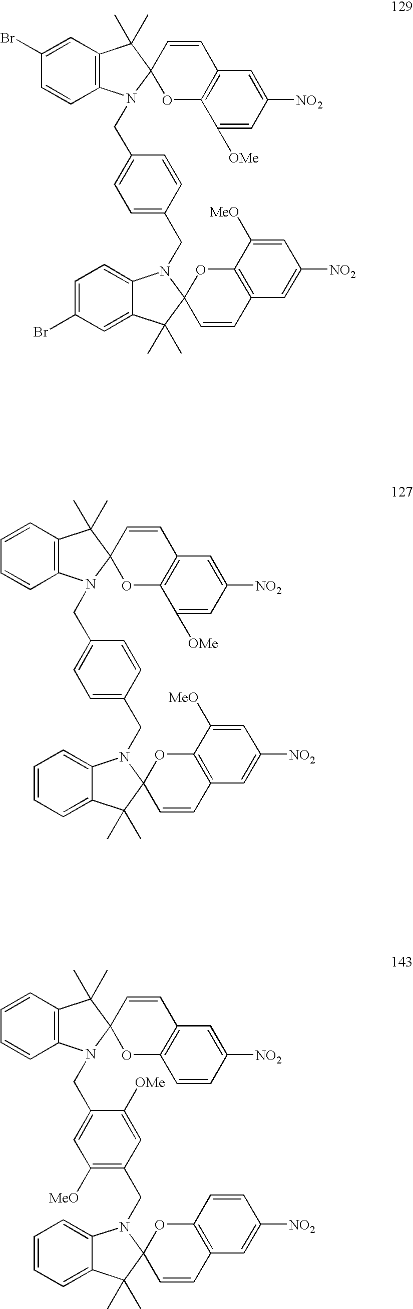

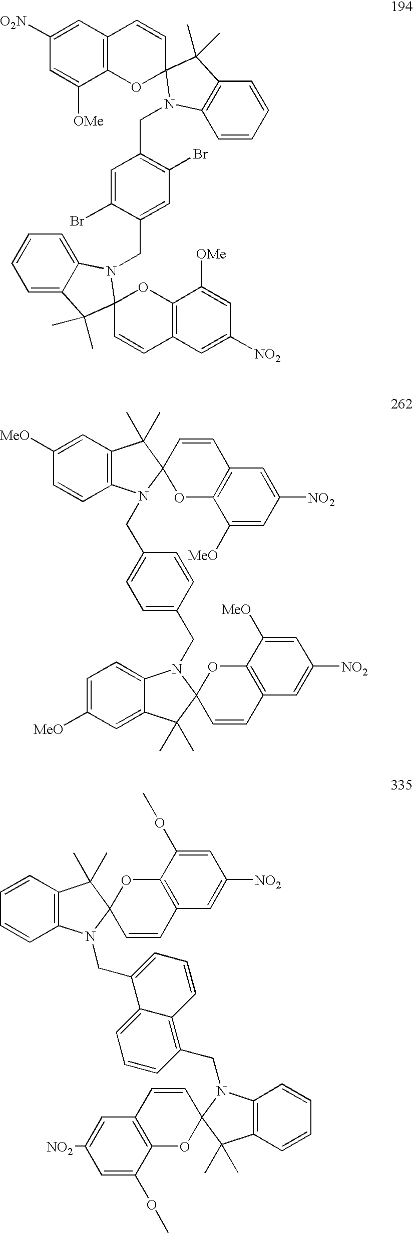

The luminescent colorant increases the color difference of the color change caused by the indicator reagent by at least 0.5 color units, preferably at least 1.0 color units and most preferred 2.0 color units.

Color differences in CIELAB units are given by

ΔE=[(ΔL*)²+(Δa*)²+(Δb*)²]^{0.5}

In the CIELAB color space, all colors are arranged around a central vertical axis, the L* axis. If the Cartesian coordinates L*, a*, and b* are converted into cylindrical coordinates, these quantify the three variables of a perceived color: lightness, saturation, and hue.

Saturation is the variable by which a surface color differs from the grey of the same lightness and is quantified by the distance from the achromatic axis. This is given by

[(a*)²+(b*)²]^{0.5}

and is also termed chroma (symbol C*)

Hue is quantified by the angle that the chroma radius, passing through the position of the color, makes with the positive a* axis; it is given by

h=arctan(b*/a*)

expressed on a scale from 0 to 360°. The relationship between these CIELAB coordinates is shown as CIELAB color space in FIG. 1 hereinafter.

The CIELAB L*, C*, and h coordinates provide a numerical identification of any color that, unlike XYZ or xy Y coordinates, could be easily understood. The L*, a*, and b* values of any color can be regarded as coordinates in a three-dimensional Euclidean space; two colors that are not a perfect match to the 2° or 10° observer under a specified illuminant are not located at the same point in L*a*b* space, and as the match is worse the greater is the separation. This distance is easily calculated by applying the Pythagorean theorem in three dimensions:

ΔE=[(ΔL*)²+(Δa*)²+(Δb*)²]^{0.5}

where
ΔL*=L_{batch}*−L_{standard}*
Δa*=a_{batch}*−a_{standard}*
Δb*=b_{batch}*−b_{standard}*
and ΔE is the color difference in CIELAB units. The value L* quantifies the lightness difference: a batch is lighter than standard if ΔL* is positive and darker if it is negative. Differences in the other two variables of perceived color, chroma and hue, are calculated as follows:

C*=[(a*)²+(b*)²]^{0.5}

ΔC*=C_{batch}*−C_{standard}*

A batch is stronger than standard if ΔC* is positive and weaker if it is negative. The hue difference, Δh, is given by

Δh=[(ΔE)²−(ΔL*)²−(ΔC*)²]^{0.5}

This can be qualified by the terms redder, more yellow, greener, or bluer by reference to the a*b* diagram.

In a preferred embodiment the luminescent colorant is a fluorescent colorant.

Fluorescent colorants differ from normal colorants in that they produce exceptionally bright colors because they not only absorb light, but also emit it. Fluorescence occurs when molecules that have absorbed light and are in their lowest excited state S₁ return to their ground state S₀ and emit light. Fluorescent colorants absorb and emit light in the visible region of the spectrum. Fluorescent colorants usually have extremely rigid, extended π-systems. Rigidity is of importance because it suppresses the release of energy due to activated nuclear vibrations. Substituents such as heavy atoms (chlorine and bromine) or nitro groups are detrimental to fluorescence because they favour intersystem crossing. Fluorescent colorants which are suitable within the meaning of the present invention must satisfy certain requirements: they must produce a pure color dictated by their absorption and emission spectra, they must have a high molar extinction, and most important, they must have a high quantum yield.

Suitable fluorescent colorants include but are not limited to naphthalimide, coumarin, xanthene, thioxanthene, naphtholactam, azlactone, methane, oxazine and thiazine dyes and or pigments and daylight fluorescent pigments, preferably Solvent Yellow 44, Solvent Yellow 160, Basic Yellow 40, Basic Red 1, Basic Violet 10 and Acid Red 52.

Another suitable fluorescent dye is Yellow S790 (Lumogen)

Suitable naphthalimide dyes and pigments include alkoxynaphthalimides, 4-aminonaphthalimides, 1′,8′-naphthoylenebenzimidazoles, imides of naphthalene-1,4,5,8-tetracarboxylic di-anhydride, 1′,8′-naphthoylenebenzimidazole peridicarboximides, bis-benzimidazole derivatives of naphthalene-1,4,5,8-tetracarboxylic acid, 1′,8′-naphthoylenepyrazoles, benzo[k,l]xanthene- and benzo[k,l]thioxanthene-3,4-dicarboximides, azo- and azomethine-naphthalimides, and perylene-3,4,9,10-tetracarboxydiimides.

The fluorescent colorant may be a pyrimido[5,4-g]pteridine derivatives of general formula (IV)

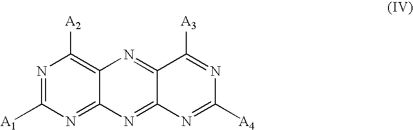

wherein
A₁, A₂, A₃, and A₄ are each independently of the others —NR₁R₂, wherein R₁ and R₂ are each independently of the others hydrogen, C₁-C₈alkyl, —CO—C₁-C₈alkyl, —CO—C₆-C₁₄aryl, —COO—C₁-C₈alkyl, —COO—C₆-C₁₄aryl, —CONH—C₁-C₈alkyl or —CONH—C₆-C₁₄aryl, or A₁, A₂, A₃, and A₄ are each independently of the others —OH, —SH, hydrogen, C₁-C₈alkyl, C₁-C₈alkoxy, or C₆-C₁₄aryl or —O—C₆-C₁₄aryl each unsubstituted or mono- or poly-substituted by halogen, nitro, cyano, —OR₁₀, —SR₁₀, —NR₁₀R₁₁, —CONR₁₀R₁₁, —COOR₁₀, —SO₂R₁₀, —SO₂NR₁₀R₁₁, —SO₃R₁₀, —NR₁₁COR₁₀ or by —NR₁₁COOR₁₀, wherein R₁₀ and R₁₁ are each independently of the others hydrogen, C₁-C₈alkyl, C₅-C₁₂cycloalkyl or C₂-C₈-alkenyl.

These compounds are described in WO1998 18866 (Ciba)

Inorganic phosphors are likewise suitable as the luminescent colorant used in the inventive color changing indicator system. Preferably, the inorganic phosphor is selected from the group consisting of sulfides and selenides including zinc and cadmium sulfides and sulfoselenides, alkaline-earth sulfides and sulfoselenides; oxysulfides; oxygen-dominant phosphors including borates, aluminates, gallates, silicates, germanates, halophosphates and phosphates, oxides, arsenates, vanadates, niobates and tantalates, sulfates, tungstates and molybdates; halide phosphors including alkali-metal halide and manganese-activated halide phosphors.

As mentioned hereinbefore, indicator systems are preferred wherein the visually distinct color signal is characterized by the transition of a pale or colorless state of the indicator reagent to a strongly colored state, or alternatively, by the discoloration of a strongly colored state of the indicator reagent to a pale or colorless state. It is especially preferred when the strongly colored state of the indicator reagent is characterized by a visually intensive blue color and when the additional colorant which increases the color difference of the color change caused by the indicator reagent by at least 0.5 is a yellow light emitting fluorescent or phosphorescent colorant.

A further aspect is a method of manufacturing a time-temperature indicator comprising a
photo- or thermochromic indicator; said method comprising the steps of
(a) introducing into a matrix or atop a matrix a photo- or thermochromic indicator according to any one of claims 1-5,
(b) applying a luminescent colorant t into a matrix or atop a matrix before or after the photo- or thermochromic indicator is applied, or
(c) optionally applying a mixture of the photo- or thermochromic indicator and the luminescent dye into a matrix or atop a matrix
(d) converting the indicator from an original stable state into a metastable state by a process selected from photonic induction, thermal induction, pressure induction, electrical induction, or chemical induction,
(e) optionally applying a protector film.

The inventive indicator system is preferably applied to a support matrix which may be a polymer such as PVC, PMMA, PEO polypropylene, polyethylene, all kinds of paper, all kinds of printing media or the like or any glass-like film. The active indicator reagent and/or the additional colorant may be introduced into and/or atop a matrix substrate such as polymers, glass, metals, paper, and the like. Such forms may be or result from indicator-doping of the matrix, sol-gel embedment of the indicator in the matrix, embedment of the indicator as small crystallites, solid solution and the like.

In one case, the depositing of the active indicator reagent and/or the luminescent colorant in the process of producing the inventive indicator system is by transforming it into a printable ink that is suitable for printing using any of the printing methods known in the art, e.g., ink jet printing, flexo printing, laser printing and the like.

The luminescent colorant may be applied to the support matrix before or after the active indicator reagent is applied to or, both constituents may be applied as a mixture to the support matrix.

An aspect of the present invention relates to the use of a luminescent colorant in an indicator system which enables to follow the course of a chemical and/or physical process or characterize the state of a chemical and/or physical system by generating a visually distinct color signal due to a color change of the indicator reagent wherein the colorant increases, or in an alternative embodiment decreases, the color difference of the color change by at least 0.5 unit, preferably at least 1.0 unit and most preferred 2.0 unit.

Yet another aspect of the present invention relates to a method of signalling the expiration of the useful life of a perishable product which comprises affixing to said product a time temperature indicator system capable of responding to ambient temperature over a period of elapsed time to provide a visually-distinct color change characterized in that the time temperature indicator system comprises (a) at least one photo- or thermochromic time temperature indicator reagent which changes its color as a function of time and temperature, and (b) a luminescent colorant which increases, or in an alternative embodiment decreases, the color difference of the color change of the at least one time temperature indicator reagent by at least 0.5 unit, preferably at least 1.0 unit and most preferred 2.0 unit.

The following examples are provided for the purpose of further illustrating the present invention but are in no way to be taken as limiting.

### EXAMPLES

A water based ink was prepared comprising:

| | | |
|---|---|---|
| (i) | Spiropyran compound (I) | 10 g |
| (ii) | GLASCOL LS16 | 40 g |
| (iii) | GLASCOL LS20 | 40 g |
| (iv) | TEGO 845 (antifoam) | 0.5 g |
| (v) | Water (distilled) | 9.5 g |

wherein (I) is:

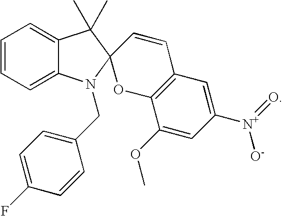

The water-based ink was divided into two parts. One part was printed over a white label whereas the other part was printed on a white label that was first printed with a fluorescent yellow dye (LUMOGEN® Yellow S790, BASF Ludwigshafen Germany).

Glacol LS20 is micro emulsion (48% solid content) of an acrylic copolymer available from Ciba.

Glascol LS16 Carboxylated acrylic copolymer available from Ciba.

This process produced two labels, one where the indicator compound (I) was printed over a white label and one where the indicator compound (I) was applied to a fluorescent yellow background.

The two labels were charged under the same conditions using a TLC lamp at 365 nm producing a strong blue color and put, in the dark, in different ovens set to different temperatures (1, 5, 10, 15, and 25° C.).

The Lab parameters of the samples were measured as a function of time and shown in the following Table

| | (L² + a² + b²)^{0.5} | | | | | | | | | |
|---|---|---|---|---|---|---|---|---|---|---|
| Time | 1° C. | | 5° C. | | 10° C. | | 15° C. | | 20° C. | |
| hours | A | B | A | B | A | B | A | B | A | B |
| 0 | 48 | 30 | 48 | 30 | 48 | 30 | 48 | 30 | 48 | 30 |
| 10 | 49 | 32 | 49 | 32 | 55 | 45 | 60 | 85 | 70 | 85 |
| 50 | 52 | 35 | 52 | 35 | 60 | 60 | 70 | 95 | 80 | 105 |
| 100 | 55 | 40 | 55 | 40 | 66 | 80 | 75 | 100 | 82 | 107 |
| 150 | 58 | 42 | 58 | 48 | 70 | 90 | 78 | 102 | 82 | 107 |
| 200 | 60 | 45 | 60 | 60 | 72 | 92 | 80 | 105 | 82 | 108 |
| 250 | 61 | 49 | 62 | | 73 | 93 | 80 | 105 | 83 | 109 |
| 300 | 62 | 52 | | | 73 | 93 | 82 | | | |
| 350 | 63 | 53 | | | 74 | 94 | | | | |
| 400 | 64 | 55 | | | 75 | 95 | | | | |
| 450 | 65 | | | | 75 | 95 | | | | |

A: The spiropyrane compound of the example printed on a white label.
B: The spiropyrane compound of the example printed on a white label that was first printed with LUMOGEN.

The change of color as a function of time (slope) is always larger in the case of the label printed on the fluorescent yellow dye. It starts at lower values and fades to higher values, producing a much larger ΔE value compared to the normal label that was printed on a white background.

1. A time temperature indicator system comprising
(a) a photo- or thermochromic indicator compound and
b) a luminescent colorant.

2. The indicator system of claim 1 wherein the indicator compound is a diarylethene or a spiroaromatic compound.

3. The indicator system of claim 2 wherein the indicator compound is a spiroaromatic compound of general formula (I) 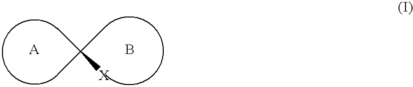
wherein
ring A represents a C5-C8 carbocycle or C4-C7 heterocycle containing at least one heteroatom selected from N, O, or S; said N heteroatom may be further substituted by one or two groups selected from C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl and —CH═CH—CN; when said N heteroatom is tetrasubstituted it is positively charged and is associated with an anion selected from the group consisting of organic and inorganic anions;
said C5-C8 carbocycle or C4-C7 heterocycle may be substituted by one or more of the groups selected from halogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, cyano, nitro, sulfo, hydroxyl, thiol, —CH═CH—CN, azido, amido and amino;
ring B represents a substituted or unsubstituted heterocycle containing at least one heteroatom X, said X being selected from N, O, and S; wherein said N atom may be further substituted by one or two groups selected from C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl and —CH═CH—CN; when said N heteroatom is tetrasubstituted it is positively charged and is associated with an anion selected from the group consisting of organic and inorganic anions;
and wherein said ring B may contain one or more endocyclic double bonds and is optionally substituted by one or more halogen;
said rings A and B may be fused to one or more substituted or unsubstituted carbocycle, C4-C14 heterocycle, C6-C14 aryl or C4-C14 heteroaryl ring system;
and wherein the compounds of general formula I may be neutral, charged, multiply charged, positively charged having an external anion, negatively charged having an external cation or zwitterionic.

4. The indicator system of claim 3 wherein the spiroaromatic compound of general formula (I) is a derivative of 1′,3′,3′-trimethyl-6-nitro-spiro(2H-1-benzopyran-2,2′-2H-indole) of general formula (II) 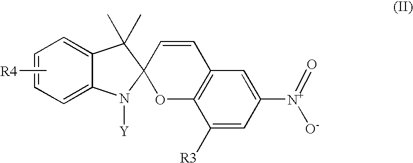
wherein
R3 is selected from the group consisting of H, halogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic and azido; wherein said alkyl, alkenyl, alkynyl, aryl, heteroaryl, and non-aromatic carbocycle may be substituted by one or more group selected from halogen, hydroxyl, thiol, amino, alkoxy, nitro, azido and sulfo;
R4 is selected from the group consisting of hydrogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl and —CH═CH—CN; and
Y is selected from the group consisting of C1-C25 alkyl and C7-C15 aralkyl, wherein said alkyl and aralkyl may be substituted by one or more group selected from halogen.

5. The indicator system of claim 3 wherein the spiroaromatic compound is a dimeric spiropyrane of the formula IV 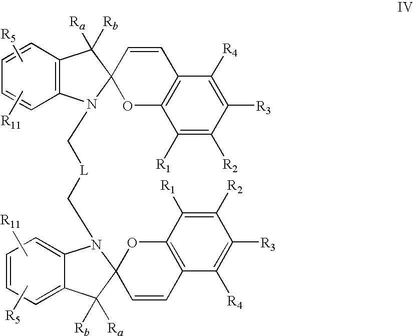
wherein
R₁ is hydrogen, —C₁-C₆ alkoxy, halogen, —C₁-C₆ alkyl or —NO₂;
R₂ is hydrogen or —C₁-C₆ alkoxy;
R₃ is NO₂ or halogen;
R₄ is hydrogen, —C₁-C₆ alkoxy or halogen;
R₅ is hydrogen, halogen, methoxy or —COOH
R₁₁ is hydrogen,
Rₐ is methyl or ethyl,
R_{b} is methyl or ethyl,
L is a divalent linker.

6. The indicator system of claim 1 wherein the luminescent colorant is a fluorescent colorant selected from the group consisting of naphthalimide, coumarin, xanthene, thioxanthene, naphtholactam, azlactone, methane, oxazine and thiazine dyes and daylight fluorescent pigments.

7. A method of manufacturing a time-temperature indicator comprising a photo- or thermochromic indicator; said method comprising the steps of
(a) introducing into a matrix or atop a matrix a photo- or thermochromic indicator according to claim 1,
(b) applying a luminescent colorant into a matrix or atop a matrix before or after the photo- or thermochromic indicator is applied, or
(c) optionally applying a mixture of the photo- or thermochromic indicator and the luminescent dye into a matrix or atop a matrix
(d) converting the indicator from an original stable state into a metastable state by a process selected from photonic induction, thermal induction, pressure induction, electrical induction and chemical induction,
(e) optionally applying a protector film.

8. A printing ink or printing ink concentrate, comprising (a) a photo- or thermochromic indicator compound and b) a luminescent colorant.

9. (canceled)

10. A time temperature indicator system according to claim 1 which generates a visually distinct color signal due to a color change of the indicator reagent wherein the luminescent colorant is chosen so that the difference of the color change is increased by at least 0.5 color unit.

11. The indicator system of claim 4 wherein in formula II Y is selected from the group consisting of methyl, n-propyl, n-octadecyl, and C7-C15 aralkyl, wherein said alkyl and aralkyl may be substituted by one or more fluorine atoms.

12. The indicator system of claim 6 wherein the luminescent colorant is a selected from the group consisting of Solvent Yellow 44, Solvent Yellow 160, Basic Yellow 40, Basic Red 1, Basic Violet 10 and Acid Red 52.
